(19) United States
(12) Patent Application Publication
(10) Pub. No.: US 2022/0176288 A1
(43) Pub. Date: Jun. 9, 2022

(54) FILTER TUBE HOLDING GROMMET FOR FILTRATION SYSTEM

(71) Applicants: David E. Sisk, Bonne Terre, MO (US); Peter Kemp, St. Louis, MO (US); Roger Breakfield, Farmington, MO (US); Andrew Boyer, Fredericktown, MO (US); Travis Kinneman, Bonne Terre, MO (US)

(72) Inventors: David E. Sisk, Bonne Terre, MO (US); Peter Kemp, St. Louis, MO (US); Roger Breakfield, Farmington, MO (US); Andrew Boyer, Fredericktown, MO (US); Travis Kinneman, Bonne Terre, MO (US)

(21) Appl. No.: 17/300,958

(22) Filed: Dec. 22, 2021

Related U.S. Application Data
(63) Continuation-in-part of application No. 63/205,694, filed on Jan. 4, 2021.
Application No. 63/205,694 is a continuation-in-part of application No. 17/300,841, filed on Nov. 22, 2021.
(60) Provisional application No. 63/205,346, filed on Dec. 3, 2020.

(51) Int. Cl. B01D 46/00; B01D 45/16; B01D 46/24; B01D 46/58; B01D 50/20; B04C 3/06; B04C 9/00

(52) U.S. Cl. CPC B01D 46/0005; B01D 45/16; B01D 46/2407; B01D 46/58; B04C 2009/004; B04C 3/06; B04C 9/00; B01D 2265/024; B01D 2271/02; B01D 50/20

(57) ABSTRACT

A dust filtering and collection system for filtering dust and other particles from an air stream generally being used for conveying granular material into or from a bulk tank, with the filtering system designed to incorporate structure, such as a specially designed grommet, for holding a porous filter tube for filtering out such dust particles, with a grommet having structure to provide for its interlocking and engagement with and through an aperture in a transverse plate within the system. The grommet has an upper flange, that engages the upper surface of the transverse plate, and has an inner flange for engagement with the upper edge of the filter tube, while the bottom of the grommet has resilient fingers and associated detents for engaging the bottom of the transverse plate, to furnish an interlocking of the grommet, with its supported filter tube, onto and through the transverse plate.

### CROSS REFERENCE TO RELATED APPLICATION

This application claims the benefit of U.S. Provisional Application No. 63/205,694, filed Jan. 4, 2021, the entirety of which is hereby incorporated by reference. This application is a continuation-in-part of U.S. patent application Ser. No. 17/300,841, filed Nov. 22, 2021, which claims the benefit of U.S. Provisional Application No. 63/205,346, filed Dec. 3, 2020, the entireties of which are hereby incorporated by reference.

### FIELD OF THE INVENTION

This invention relates to the various components utilized in a filtration system, of the spin flow inlet/outlet type of air filtering means, usually used in conjunction with bulk granular material conveying vehicles, and more specifically pertains to improved structure for mounting of the filtration tubes within their centrifugal filtration structure, and the various style of grommets that are utilized to hold the filter tubes securely in place, so as to prevent and reduce the incidence of filter tube displacement, or failure, which can lead towards the total inefficiency of operations of the filtration system, when cleansing the conveying air of dust and debris it has collected from moving the granular material for further usage and application, during loading and unloading of such material from a tank trailer, railroad car, or other conveying means or vehicle.

### BACKGROUND OF THE INVENTION

This present invention relates to dust filtering and collection systems and is more concerned with the structure that is embodied within the filtration device, particularly its grommet, for use in holding various filtration tubes, that are utilized for filtering out the dust particles and other miniscule debris from the air that was used for conveying granular material, into or from the conveying vehicle, during its usage. Thus, previous filtering devices, for filtering the air that is utilized for moving grain, etc., for conveying purposes, are generally designed for achieving efficiency and separation of the dust and debris from the air being filtered. More specifically, in the dry bulk conveyance of granular materials, such as grains, flour, and the like, where various suction lines and vacuums are generated to provide for the conveyance of such granular materials, to or from their storage or conveying bins, that such grains, as may be moved to and from a silo, tank trailer, railroad car, and other dry bulk trailers, dust from the granular materials becomes suspended in the conveying air, so that some of the product remains in the air after the product is conveyed from its storage tank into the transport tank, as well as from the transport tank into its destination tank. The dust in the air, if drawn into a blower, as happens in vacuum conveying, clogs the blower requiring expensive repairs or blower replacement. Also, if the dusty air is vented to the surrounding atmosphere, it presents an inhalation health hazard or explosion hazard. It is therefore desirable to provide means to separate the dust from the conveying air. Additionally, the dust in this case is the product that is conveyed and can be recovered back into the tank to recover the value in the dust. The present invention relates to such dust filtering and collection systems, and more particularly pertains to specific structure for the various components that hold the filtration system together, to assure that it maintains efficiency of operation, throughout the useful life of the system, so as to comply with any and all regulations that may be enforced, pertaining to the handling of such type of granular materials, particularly during its conveyance and transfer.

More specifically, with respect to the current invention, that is used in a filtration canister, whether it be one that the air enters directly into its filter housing, or is tangentially applied into such housing, the plurality of filtration tubes that have long been used within such filtration systems, are supported at their upper ends by a transverse plate, while the lower ends of such tubes are crimped or sealed into closure; these tubes being made generally of a polymer, that have very miniscule openings through them, in the range of microns of porosity, so as to filter the incoming air as it passes through the tubes in the filtration system, and to purify it for its further usage in the air conveying of such granular materials, during its handling. And, while such filtration systems, within their filter housing, includes a transverse plate, in which such tubes are mounted, they usually are each held in place by a grommet that is pressured into position, it has been found, with these prior art type of filters, that when dust or other fine debris clogs up the porosity of such tubes, and the pressure of the incoming air may be in the range 20-30 psi, they on occasion would force the tubes upwardly, out of their engaged grommet as held within the associated transverse plate, thereby providing a direct opening for passage of the dust and soiled air out of the filtering system, bypassing it, receiving completely adulterated air, which means that it is then inadvertently passed through the blower, and leading to a complete failure of the identified type of filtration system. Such a filtration system can be seen in the assignee's prior U.S. Pat. No. 5,053,063, as can be noted therein.

That previous U.S. Pat. No. 5,053,063, upon the dust filtering and collection system, as noted, shows the overall assembly of the prior art type of various structures making up the storage tank of the dry bulk trailer, including its elongated storage tank, the dust filtering and collecting canister associated therewith, and its filtration tubes that are provided within the canister, in addition to the flow paths for the various air lines that provide for conduct of the dust laden air stream into the filtering canister, and then through the filtration device, and the other flow lines associated with the conveyance of the dust to the primary discharge line that uses pressurized air to convey the granular material or grains for unloading from the tank trailer, and to the site of its usage or storage. That previous disclosure provides an overall analysis of the bulk tank vehicle storage tank, and its various air conveying lines, and the filtration device used therein, during its processing of granular material. The United States patent to one of the inventors herein, U.S. Pat. No. 8,657,898, also depicts an air filter spin flow inlet/outlet housing, which shows a separate type of structure for filtering of the air used in the conveying of bulk granular materials from a tank trailer, such as the type that also uses air pressure to achieve granular or grain flow, and its distinct air filtration unit incorporating an intake that induces a spiral flow, upon entering of its associated filtering device. The concept of the current invention is to provide for a further restructuring of the air filtration system of the bulk tank granular material conveying system, and more specifically towards the structures that are utilized to hold the plurality of filter tubes to the transverse plate mounted within the filter canister, and the application of a specially designed grommet, for securing each tube to its associated plate, so as to assure that the tubes do not become separated from their supporting plate, when subjected to the elevated pressurized air that impinges upon the tubes, during performance of a filtration process, which, in the past, has caused failure, for reasons as previously described. These are examples of prior art known to the Applicants of the improvements embodied within the herein described invention.

To provide clarity with respect to the failures encountered with prior grommets or sleeves for use in holding filtration tubes in place, with respect to their supporting transverse plate, when held within the filtration canister, reference is made to FIG. 7. As can be noted, the prior grommets G, holding the filtration tube T, of the type as previously described, would normally be pressure fitted through an aperture, as at A, provided through the transverse plate P as can be noted. But, when pressure would build up upon the tube T, as when dust particles or miniscule debris would fill into the various porous apertures of each filtration tube, pressure would build up on the tube, from the incoming air that enters into the filtration canister and would force the grommet G and its tube T upwardly, and forcefully push it out of the plate aperture A, as can be noted. When this occurred, the tube would be free to shift within the plate, and would generate an oversized hole, as at H, leaving a substantial gap through which the particulate, such as dust particles and associated debris, can pass through, and enter into the mainstream of the otherwise purified air that would enter into and out of the chamber above the transverse plate, thereby adulterating the air that is drawn into the blower or vented to atmosphere, when it is loaded or unloaded from the tank trailer, or other vehicle, with which the filtration system is associated. Hence, such failure was just unacceptable, and did not pass regulation or standards as required for the processing of such material, particularly if it is the type that is of food grade, for use in the manufacture and processing of edible food products. The current invention has been designed to overcome this type of a problem with prior art filters.

These are examples of the prior art known and relating to such filtration systems, and the improvements to be described herein, that remedy such deficiencies.

### SUMMARY OF THE INVENTION

The primary concept of this invention is to provide improvements to the grommet or sleeve that cooperates with a filtration tube, within a filter canister, so that inadvertent problems do not occur in the mounting of such filtration tubes, that can lead towards the type of deficiencies as previously explained in the background herein. Generally, this invention contemplates the provision of various structural relationships between the specially formed grommet, the filtration tube which it is designed to secure, to the transverse plate of the filtration system for a granular material conveying vehicle.

Generally, the specially formed grommet will be formed of rubber, or a polymer, such as urethane, or related materials, and which has a degree of resiliency so as to allow for the grommet, when supporting its associated filter tube, to be forcefully applied within the transverse plate provided mounting within the canister of a filtration system. The grommet may include various flanges, grooves, detent means, barbs, all designed to rigidly secure the filtration tube within the grommet, and to interengage the grommet within and through a particular aperture in which it locates through of the transverse plate mounted within the canister of the system.

Initially, the grommet has a channel therethrough, of sufficient size to provide for the locating of the filter tube therein, and even bonding within the associated grommet, with the grommet flange engaging upon the top of the tube, to prevent it from moving upwardly, when subjected to excessive pressure, particularly when its porous filtering apertures have become clogged with dust particles, and fine debris, during repeated usage. That structural relationship prevents the tube from further rising upwardly, above the plate, once it is fixed into position, and employed for filtering purposes. Also, an internal groove engages with a flange formed on the top of the tube to hold the tube and prevent the tube from sliding downward through the plate. The central channel through the grommet has a textured surface (e.g., texture applied), such as a knurl, to further grip the tube to prevent slipping of the tube relative to the grommet during assembly and when under pressure (e.g., during use). In addition, the grommet has an outer extending flange, at its upper edge, which biases upon the surface of the subjacent transverse plate or sheet, that is designed for holding a plurality of the filtration tubes, in position, as will be subsequently described. Furthermore, the grommet has one or more grooves, each of which may contain a further 0-ring, to provide further sealing between the grommet, and the inner surface of the plate aperture, through which the grommet and filter tube extend. Alternatively, the O-ring is integrated to the grommet. In other words, the grommet has one or more O-ring ribs to provide further sealing between the grommet and the inner surface of the plate aperture through which the grommet and filter tube extend. Furthermore, the bottom of the grommet is integrally formed having a form of detent, hook, or barb, which when the grommet and its tube are forcefully applied through the plate aperture, the barbs can hook onto the undersurface of the transverse plate, and therefore provide for an interlocking of the grommet, with the edge of the associated plate aperture, once installed.

Furthermore, and in the preferred embodiment, the grommet has a series of downwardly extending spacings or relief cuts provided between the barbs, so as to allow for the barbs to flex inwardly, or to spread laterally, to add clearance for forceful insertion of the grommet into the tube plate aperture, when the grommet and its associated tube are installed therethrough, in preparation for usage. These relief cuts between the barbs form flexibility, so that the barbs can be pushed through the hole in the transverse tube sheet, during assembly. The relief cuts between the barbs do flex inwardly, and somewhat laterally, into their associated spacings, to assure that each grommet can be installed into position within the plate, during assembly. Then, when pushed fully through the plate aperture, the detents or barbs at the bottom of the grommet snap under and engage the undersurface of the transverse plate, adjacent its plate aperture, in order to lock the grommet into position, and to prevent it, and its associated mounted filter tube, from rising upwardly when subjected to excessive pressures as previously explained. The relief cuts do not go all of the way through the grommet creating a cylindrical portion connecting the bars, holding the barbs in position relative to each other during assembly and/or use.

Obviously, the flexibility of the grommet, and its associated fingers, must be of a certain degree of durometer hardness, and it has been found that a shore A durometer hardness in the range of 45 to 95, will operate effectively for installation purposes when the filtration system is assembled, and yet has sufficient hardness to lock the grommet and its tube into position, and not be forced out of its plate aperture, during sustained usage. The preferred durometer hardness is approximately 55, shore A.

Thus, the principal object of this invention is to provide means for more permanent securement of porous filtration tubes within the canister of a filtration system, by utilizing a specially designed grommet that locks the tubes into position with respect to their supporting transverse plate or tube sheet.

Another object of this invention is to provide the structure for interlocking a filter tube within its supporting sleeve or grommet that interconnects with both the top and the bottom of the supporting transverse plate of the filter canister or housing.

A further object of this invention is to provide a grommet, for holding filtration tubes into position within its supporting plate, by interconnecting with the undersurface of the plate, once installed.

Another object of this invention is to provide a grommet, that integrally provides space between its lower extending stems, to provide for spreading the stem fingers laterally as the grommet is forced into the tube sheet during installation.

Yet another object of this invention is to provide a grommet, for holding a filter tube, and which has formed elasticity or resiliency, to allow for installation, but yet have sufficient resilient structure, to firmly hold its supported filtration tube into place once installed, and during performance of a filtering operation.

Another object of this invention is to provide resilient sleeve or grommet that may be made of rubber or flexible polymer, to facilitate the installation of the filter tube supported grommet within the tube sheet or plate of the filter housing.

These and other objects may become more apparent to those skilled in the art upon review of the Summary of the Invention as provided herein, and upon undertaking a study of its Description of its Preferred Embodiment, in view of the drawings.

### BRIEF DESCRIPTION OF THE DRAWINGS

In referring to the drawings,

FIG. 1 is a sectional view of the filtration housing and its various filter tubes mounted therein when used for filtering the air to eliminate dust particles and small debris from the air to be used for conveying purposes of granular material to and from the ladened vehicle;

FIG. 2 is a sectional view of the supporting grommet holding its filter tube within the transverse plate of the filtration housing;

FIG. 3 provides a perspective view of the filter tube supporting grommet of this invention;

FIG. 4 is a top plan view of the grommet of FIG. 3;

FIG. 5 is a bottom view thereof;

FIG. 6 is a front view of the filter tube supporting grommet;

FIG. 7, as previously reviewed, shows a prior art style of grommet that failed to hold the filter tube in position within the filtration system;

FIG. 8 provides a perspective view of the modification to the grommet of this invention;

FIG. 8A shows a front view of the grommet of FIG. 8;

FIG. 8B shows a side view of the grommet of FIG. 8;

FIG. 8C shows a back view of the grommet of FIG. 8;

FIG. 8D is a top plan view of the grommet of FIG. 8; and

FIG. 8E is a bottom view of the grommet of FIG. 8.

### DESCRIPTION OF THE PREFERRED EMBODIMENT

It is the further concept of this invention, and the various improvements that it makes to the filtration of the air that is used to provide the transfer of granular material from various storage spaces, to a tank trailer, railroad car, or the like, and the processing of that air flow in order to keep it clean, reduced of any impurities and dust, so that it does not damage the blower or cause an inhalation hazard or explosion hazard. Generally the overall appearance of this air filtration system, as noted at 1, can be seen in FIG. 1. Essentially, the improvements to the invention herein have to do with maintaining the integrity of the various components that achieve the filtering of such moving air, and to prevent these components from failure due to prolonged usage, and when subjected to significant pressures, generated from the processed air, and to assure that the various components that make up the filtration system, including its filtration tubes 2, as supported by the mounted transverse plate 3 furnished in the upper segment of the filter housing 4 and the various grommets or tailored sleeves 5 that support and hold each tube in position, possess interlocking capabilities that ensure that the tubes remain suspended within the filter housing, even when subjected to the significant air pressures from the conveyed air as it circulates through the conveyance system, for transfer of the granular material either to or from the bulk tank of the tank trailer, and while such air is being further filtered, of impurities, to assure that the fine material being conveyed remains unadulterated, in preparation for its further usage or storage. As previously explained in our earlier patent application, the filter housing 4 has an inlet, as at 6, at its bottom end, with a tapered outlet 7 integrated with the bottom of the housing 4, where the dust particles and fine debris can accumulate, and be removed, through the opening of the valve 8, as can be understood. As noted, the air line 9 that delivers the conveyed air to the filtration system orients the air into the housing 4 in a downward angular direction, as noted at 6, so as to clear such fast moving air from the bottom 10 of the filtration tubes, in preparation for the filtering action of the system. As previously explained in our co-pending application, these filter tubes are closed, molded, or crimped at their bottoms, so that the air as it rises within the housing 4, to achieve filtering, passes through the porous openings furnished through the said tubes, these porous tubes being made in accordance with the description of them as previously summarized in this application, and in our said co-pending patent application.

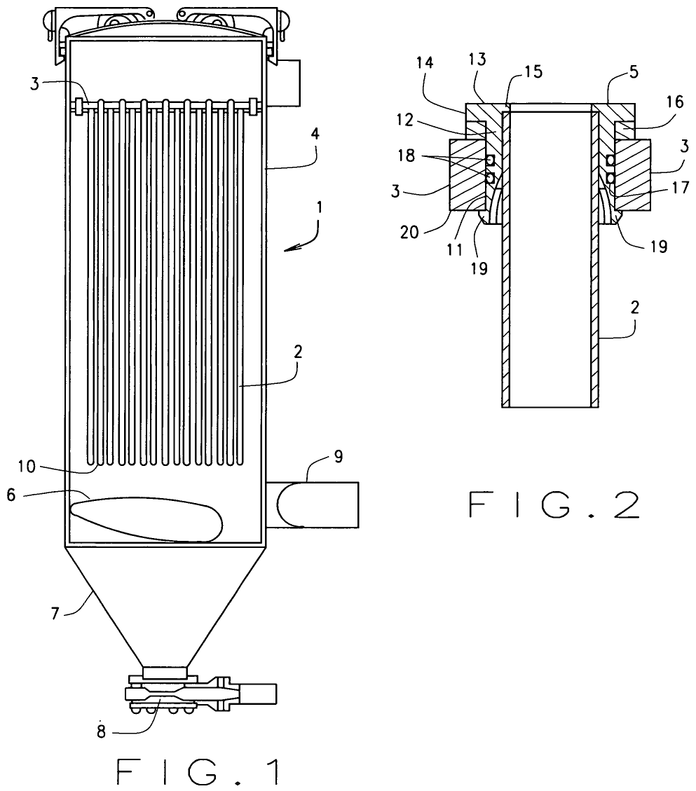

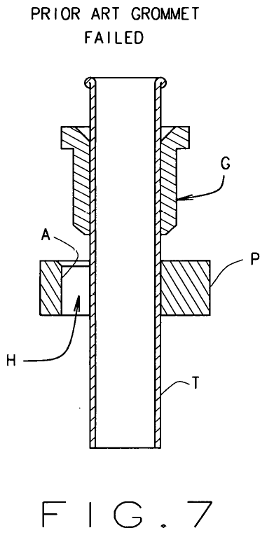

The relationship of the grommet 5, the filter tube 2, as all mounted within and extending through an aperture 11 through the transverse plate or sheet 3, can be seen in FIG. 2.

Whereas prior art types of filtered tubes were not clearly supported or interlocked with their sleeves mounted within the filter plate, and therefore, when clogging of the porous tubes would occur, from the entering of the dust particles and miniscule debris within their porous channels, this pressure build up would force the tubes, and their supporting sleeves, upwardly, out of the supporting transfer plate 3, and therefore, as previously reviewed with respect to FIG. 7, left major gaps for passage of dust laden air, bypassing the filtration system, meaning that adulterated air was being drawn into the blower or exhausted to the surrounding atmosphere.

In the grommet configuration as shown in FIG. 2, it includes a downwardly extending integral sleeve like member, as at 12, and into which the filter tube 2 would locate, with the upper end 13 of the grommet having a compound flange, that outwardly extending flange portion 14 and a slightly inwardly extending flange portion 15, the latter providing an abutment against the upper end of the filter tube 2, as can be noted, to prevent the tube from rising up out of the grommet, as can be seen. The outwardly extending flange 14 acts as a positioner for holding an annular seal 16 in place, like a flat 0-ring, biasing it against the upper surface of the contiguous transverse plate 3, to seal the upper portion of the grommet in place, when holding the filter tube 2, located through the said plate 3. At approximate the midpoint of the sleeve 12, of the grommet, are a series of annular grooves, as at 17, and these are provided for holding the 0-rings 18 sealed against the inner edges of the plate 3 aperture, to add further sealing of the filtration system, at this location, to prevent the bypass of any soiled air, from the filter tubes, during operations of the system. Preferably, the inside diameter of the grommet is approximately the same as the outside diameter of the associated tube.

Integrally, at the bottom of each of the grommets, as noted at 19, are integral detents, as noted, and these detents are designed for embracing the undersurface, as at 20, of the plate 3, to provide for an interlocking of the grommet, supporting its filter tube 2, in position with respect to its associated supporting transverse plate 3, so as to prevent any inadvertent disengagement of the filter tube, and its grommet, from the plate, once the latter had been installed in place for usage.

As previously reviewed, the grommet may be formed of a rubber material, a polymer, such as urethane, and has resiliency, so that when the grommet, with its tube, is forcefully placed through the plate aperture 11, these components become interlocked within each other, and with the supporting transverse plate 3, as can be noted. The durometer hardness, as previously reviewed, of these grommet components may be in the vicinity of 55, and generally are formed within a durometer range of approximately 45 to 95, to provide for satisfactory usage, and resiliency for application, when the filter tube and its grommet are forced through the transverse supporting plate, as explained.

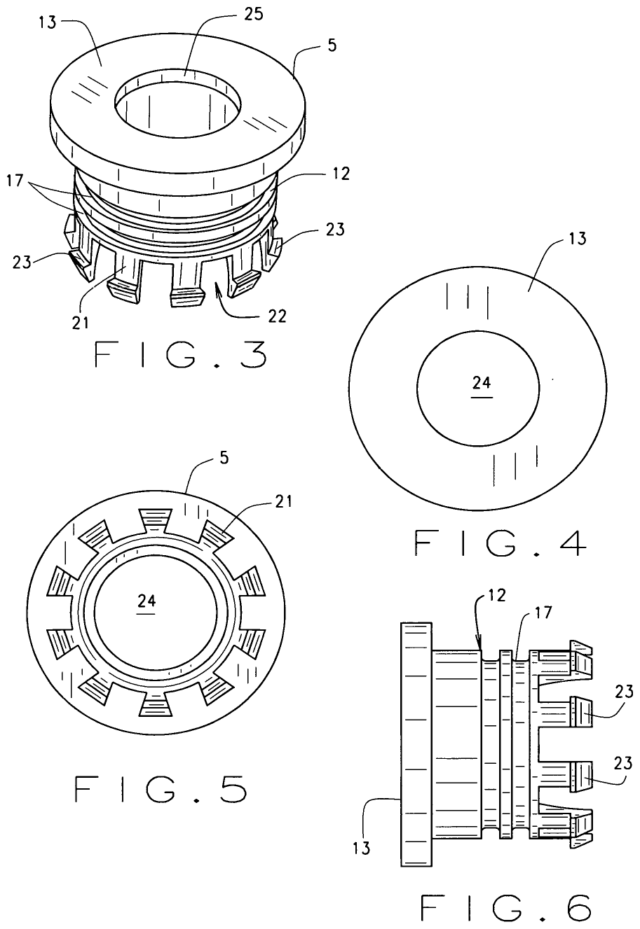

The specific design for the grommet 5 of this invention can be better seen in FIGS. 3-6. The compound flange 13 is integrally formed upwardly upon the grommet central sleeve like portion 12, and also shown are the various grooves 17, that are designed for accommodating and holding the previously identified 0-rings 18, to assure further sealing of the grommet when installed within the transverse plate 3, as noted. Integrally formed downwardly of the sleeve like portion 12 of each grommet are a series of downwardly extending stems 21, which are oriented like spaced fingers, having spacings 22 between each finger, and as can be seen each of these fingers have an outwardly extending detent 23 which when the grommet is forced through the plate 3 aperture, the detents formed like barbs, engage underneath the plate, as along its bottom surface 20, as previously explained.

Furthermore, because, as described, the grommet is made of a resilient type of material, whether it be rubber, polymer, or the like, as the grommet is forcefully applied through the plate, these fingers will widen, into their spacings 22, to allow for the grommet to slide into through and the plate aperture, during installation. This will occur even after the filter tube 2 has already been placed within the identified grommet 5, or the grommet will separately be applied into and through the plate aperture 11, until it is fully installed, binding against both the upper and lower surfaces of the contiguous transverse plate, and thereafter, a filter tube 2 may be forced upwardly, into the grommet opening, as noted, until it binds against the inward flange 15, to attain full installation and ready for its usage within the filtration system of this invention.

As can be so clearly seen within these identified figures, the grommet has its opening 24 that extends entirely through its structure, and said opening communicates with the upper opening 25 furnished through its integral flange 13, as previously explained.

Thus, the structure of the components that completely secure the grommet, its supported filter tube 2, all within and through the aperture of the transverse plate 3, of the filter housing, are readily disclosed herein, and to achieve the beneficial results for firmly securing all of these components together, so as to eliminate the type of problems that have occurred with the prior art form of structures, as previously installed and used within earlier filtration systems.

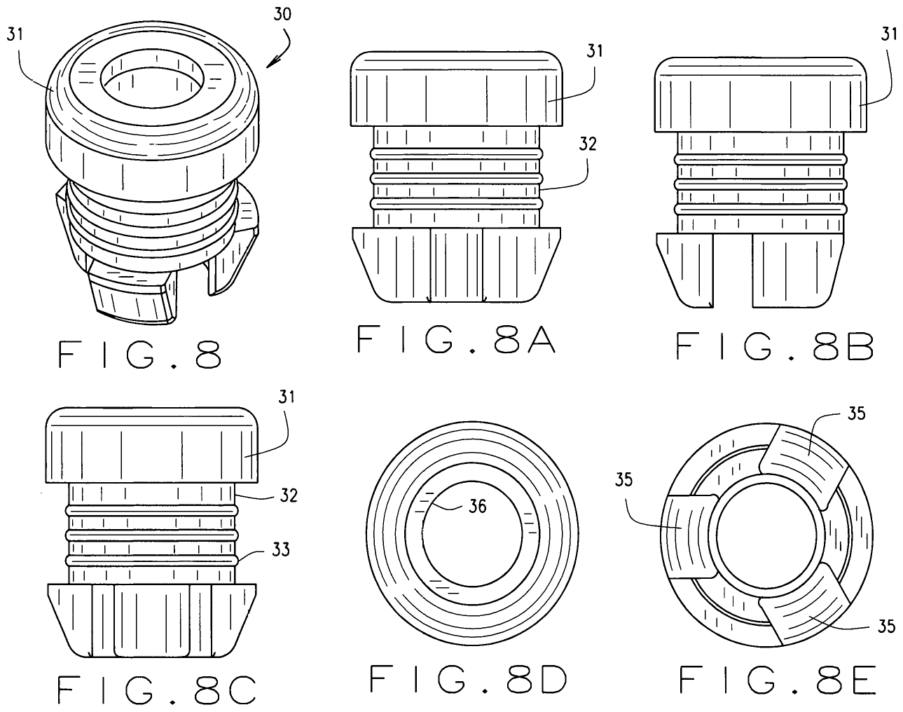

FIG. 8 shows the perspective view of the grommet, 30, as modified. The grommet includes a top structure portion 31, an integral middle portion 32, and as can be seen, the middle portion has a series of integrally formed 0-Ring seals 33, which bias against the inner edge of the opening provided through the transverse plate, as previously explained, when the grommet is inserted therethrough, during application. Downwardly from the middle portion are the integral lower extending detents 34 which in this particular design, include three barb like structures 35, as noted, and these detents embrace the undersurface of the transverse plate, as previously explained, when these grommets are fully inserted into position, and for holding the upper ends of the filter tubes, in place, once installed. It can be seen there is an aperture, or channel, 36, that extends entirely through the formed grommet 30, and into which the filter tubes locate. And, the upper portion 31 of the grommet has that same flange like member 15, as previously reviewed in FIG. 2, and against which the upper edge of the filter tube contacts, to prevent any further upward movement of the tube, as previously reviewed.

Variations or modifications to the subject matter of this invention may occur to those skilled in the art upon review of the development as provided herein. Such variations, if within the spirit of this invention, are intended to be encompassed within the scope of any claims to patent protection issuing herein. The explanation of the invention in the Description of the Preferred Embodiment, and its specific structure for achieving the beneficial results of this development, and as depicted in the drawings, are generally set forth for illustrative purposes only.

We claim:

1. A dust filtering and collection system for use in a multiple loading/unloading vehicle, such as a tank trailer, and said system for use for removing granular material by way of an air conveying source to and from a storage chamber, or the like, comprising:
a dust filtering housing, said housing having an upper end and a lower end, an air inlet provided approximate the lower end of the housing, and an air outlet provided approximate the upper end of said housing;
a dust filtering system suspended within said filter housing, a transverse plate provided in the upper segment of said housing, at least one filtration tube suspended from the transverse plate and extending partially downwardly into the filter housing, a grommet provided for extending through said transverse plate and provided for holding the filtration tube suspended from the said transverse plate, said transverse plate having an aperture provided therethrough, said grommet provided for locating through said transverse plate aperture, said grommet having an upper flange for engaging the upper surface of the transverse plate, and said grommet having a lower detent for engaging the under surface of said transverse plate, said grommet having a channel provided through it from its upper end to its lower end, and said filtration tube extending into said grommet aperture, and secured therein, thereby providing structural support for the filtration tube for the filtering of the incoming air to remove its dust particles and other debris as said air passes through the filtration housing of said system.

2. The dust filtering and collection system of claim 1, wherein there are a plurality of grommets, and associated filtration tubes, provided within the filter housing, and suspended from its transverse plate.

3. The dust filtering and collection system of claim 2, wherein the incoming dust ladened air emanates from a storage bin of the dry bulk tank trailer.

4. The dust filtering and collection system of claim 1, wherein there is a closure member provided at the top of the filtration housing, and with the transverse plate provided downwardly therefrom, forms a clean air chamber and furnishes the clean air outlet after the dust ladened air is filtered by the filtration system.

5. The air filtration and collection system of claim 2, wherein each filtration tube is secured within a grommet that engages the transverse plate so as to prevent any disengagement of the grommet, and its supported filtration tube, when subjected to the high pressures of the dusty air entering into the filter housing during usage of the filtration system.

6. The dust filtering and collection system of claim 5, wherein each grommet includes an annular sleeve like recess between its upper flange, and the lower structured detents, and into which the transverse plate locates, for locking and holding each grommet, and its associated filtration tube, in position during installation and operations of the filtering system of this invention.

7. The air filtration and collection system of claim 6, wherein each grommet has at least one groove provided around its annual sleeve like recess, and into which an 0-ring is applied for sealing the grommet against the inner surface of the transverse plate aperture into which the grommet locates during its installation.

8. The dust filtering and collection system of claim 6, wherein the sleeve like annual recess of each grommet has at least one stem extending downwardly therefrom, and said stem integrally forms a detent, at its bottom end, and which is provided for engagement with the undersurface of the transverse plate after installation of a grommet through the associated plate aperture.

9. The dust filtering and collection of claim 8, wherein there are a plurality of downwardly extending stems, with each stem having a detent formed at its lower end, and there being spacing between each of the downwardly extending stems, to allow for expansion of said stems into its said adjacent spacings to furnish clearance for the installation of the grommet, and its associated filtration tube when installed within the transverse plate in preparation for usage of the filtration system.

10. The dust filtering and collection system of claim 1, wherein each grommet has a durometer hardness between about 45 and 95.

11. The dust filtering and collection system of claim 10, wherein the durometer hardness of each grommet is approximately 55.

12. The dust filtering and collection system of claim 5, wherein there are at least two structured detents provided at the lower portion of each formed grommet.

13. The dust filtering and collection system of claim 12, wherein there are three lower structure integral detents provided upon each grommet.

14. The dust filtering and collection system of claim 1, wherein the filter tube includes a flange extending radially outward from a tube body, and wherein the grommet includes an annular groove extending about the inner circumference of the grommet, the annular groove adapted and configured to receive the flange of the filter tube to lock the filter tube into the annular groove.

15. The dust filtering and collection system of claim 1, wherein the air inlet provided approximate the lower end of the housing provides for the entrance of air centrifugally into the housing in preparation for its cleansing.
